(19) United States
(12) Patent Application Publication
(10) Pub. No.: US 2009/0232567 A1
(43) Pub. Date: Sep. 17, 2009

(54) FIXING DEVICE, CYLINDRICAL HEAT FIXING ROLL AND IMAGE FORMING DEVICE

(76) Inventor: Motofumi Baba, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 12/398,606

(22) Filed: Mar. 5, 2009

(30) Foreign Application Priority Data
Mar. 12, 2008 (JP) 2008-062890

(51) Int. Cl. G03G 15/20

(52) U.S. Cl. 399/329; 399/333

(57) ABSTRACT

A fixing device includes: a magnetic field generating unit that generates a magnetic field; a cylindrical fixing member that is disposed to face the magnetic field generating unit, generates heat due to electromagnetic induction of the magnetic field, and includes a heat generating layer that has a thickness thinner than a skin depth, and a temperature sensing layer which has a magnetic permeability change starting temperature, in a temperature range from a set fixing temperature to a heat resisting temperature, at which a magnetic permeability starts to decrease continuously, and which contacts with a face of the heat generating layer opposite to the magnetic field generating unit; and a pressure rotating body that is brought into pressure contact with an outer peripheral surface of the fixing member and deformed.

### CROSS-REFERENCE TO RELATED APPLICATION

This application is based on and claims priority under 35 USC 119 from Japanese Patent Application No. 2008-062890 filed on Mar. 12, 2008.

### BACKGROUND

### Technical Field

The present invention relates to a fixing device, cylindrical heat fixing roll used in the fixing device and an image forming device.

### SUMMARY

A first aspect of the present invention is a fixing device including: a magnetic field generating unit that generates a magnetic field; a cylindrical fixing member that is disposed so as to face to the magnetic field generating unit, generates heat due to electromagnetic induction of the magnetic field, and includes a heat generating layer that has a thickness thinner than a skin depth, and a temperature sensing layer which has a magnetic permeability change starting temperature, in a temperature range from a set fixing temperature to a heat resisting temperature, at which a magnetic permeability starts to decrease continuously, and which contacts with a face of the heat generating layer opposite to the magnetic field generating unit; and a pressure rotating body that is brought into pressure contact with an outer peripheral surface of the fixing member so as to deform.

### BRIEF DESCRIPTION OF THE DRAWINGS

Exemplary embodiments of the invention will be described in detail based on the following figures, wherein:

FIG. 1 is a general view of an image forming device in accordance with a first exemplary embodiment of the invention;

FIG. 2A is a cross sectional view of a fixing device in accordance with the first exemplary embodiment of the invention;

FIG. 2B is a cross sectional view of a fixing roll in accordance with the first exemplary embodiment of the invention;

FIG. 3 is a connection diagram of a control circuit and a energizing circuit in accordance with the first exemplary embodiment of the invention;

FIG. 4 is a schematic view showing a relation between a magnetic permeability and a temperature;

FIG. 5 is a graph showing a temperature distribution of a fixing roll in accordance with the first exemplary embodiment of the invention;

FIG. 6 is a cross sectional view of a fixing device in accordance with a second exemplary embodiment of the invention;

FIGS. 7A and 7B are schematic views showing a state in which a magnetic field passes through a fixing roll in accordance with the second exemplary embodiment of the invention; and

FIG. 8 is a graph showing a temperature distribution of the fixing roll in accordance with the second exemplary embodiment of the invention.

### DETAILED DESCRIPTION

A description will be given of exemplary embodiments of a fixing device and an image forming device in accordance with the present invention with reference to the accompanying drawings.

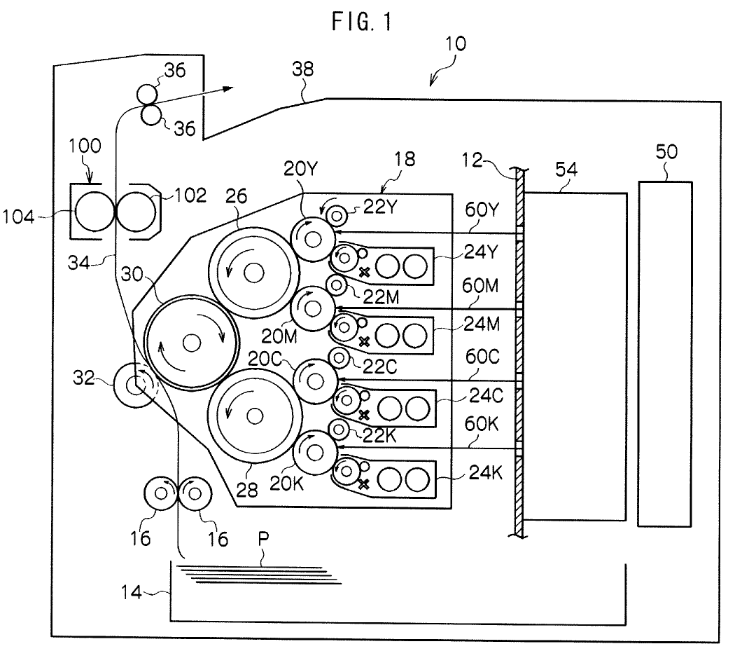

A printer 10 serving as the image forming device is shown in FIG. 1. The printer 10 is structured such that a light scanning device 54 is fixed to a casing 12 constructing a main body of the printer 10, and a control unit 50 controlling the operations of each of sections of the light scanning device 54 and the printer 10 is provided at a position which is adjacent to the light scanning device 54.

The light scanning device 54 is structured such as to scan a light beam emitted from a light source (not shown) by a rotating polygon mirror, reflect by plural optical parts such as reflection mirrors, and emit light beams 60Y, 60M, 60C and 60K corresponding to respective toners of yellow (Y), magenta (M), cyan (C) and black (K). The light beams 60Y, 60M, 60C and 60K are introduced to respective photoconductive bodies 20Y, 20M, 20C and 20K.

A sheet tray 14 storing recording sheets P is provided in a lower side of the printer 10. A pair of registration rolls 16 regulating a position of a lead edge portion of the recording sheet P are provided above the sheet tray 14. Further, an image forming unit 18 is provided in a center portion of the printer 10. The image forming unit 18 is provided with four photoconductive bodies 20Y, 20M, 20C and 20K mentioned above and these photoconductive bodies are arranged vertically in a row.

Charging rollers 22Y, 22M, 22C and 22K charging surfaces of the photoconductive bodies 20Y, 20M, 20C and 20K are provided in an upstream side in a rotating direction of the photoconductive bodies 20Y, 20M, 20C and 20K. Further, developing devices 24Y, 24M, 24C and 24K developing respective toners Y, M, C and K on the photoconductive bodies 20Y, 20M, 20C and 20K are provided in a downstream side in a rotating direction of the photoconductive bodies 20Y, 20M, 20C and 20K.

On the other hand, a first intermediate transfer body 26 comes into contact with the photoconductive bodies 20Y and 20M, and a second intermediate transfer body 28 comes into contact with the photoconductive bodies 20C and 20K. Further, a third intermediate transfer body 30 comes into contact with the first intermediate transfer body 26 and the second intermediate transfer body 28. A transfer roll 32 is provided at a position opposing to the third intermediate transfer body 30. The recording sheet P is transported between the transfer roll 32 and the third intermediate transfer body 30, and the toner image on the third intermediate transfer body 30 is transferred to the recording sheet P.

A fixing device 100 is provided in a downstream of a sheet transport path 34 in which the recording sheet P is transported. The fixing device 100 has a fixing roll 102 and a pressure roll 104, and fixed the toner image to the recording sheet P by heating and pressurizing the recording sheet P. The recording sheet P on which the toner image is fixed is output to a tray 38 provided in an upper portion of the printer 10 by a sheet transport roll 36.

A description will be given here of an image formation of the printer 10.

When the image formation is started, the surfaces of the photoconductive bodies 20Y to 20K are uniformly charged by the charging rollers 22Y to 22K, respectively. The surfaces of the charged photoconductive bodies 20Y to 20K are irradiated with light beams 60Y to 60K corresponding to an output image emitted from the light scanning device 54, and electrostatic latent images corresponding to the respective color separation images are formed on the photoconductive bodies 20Y to 20K. The developing devices 24Y to 24K selectively apply the toners of the respective colors, that is, Y to K to the electrostatic latent images, and the toner images of the colors Y to K are formed on the photoconductive bodies 20Y to 20K.

Thereafter, the toner image of the magenta is primarily transferred to the first intermediate transfer body 26 from the photoconductive body 20M for magenta. Further, the toner image of the yellow is primarily transferred to the first intermediate transfer body 26 from the photoconductive body 20Y for yellow, and is superposed on the toner image of the magenta on the first intermediate transfer body 26.

On the other hand, the toner image for the black is primarily transferred to the second intermediate transfer body 28 from the photoconductive body 20K for black in the same manner. Further, the toner image of the cyan is primarily transferred to the second intermediate transfer body 28 from the photoconductive body 20C for cyan, and is superposed on the toner image of the black on the second intermediate transfer body 28.

The magenta and yellow toner images primarily transferred to the first intermediate transfer body 26 are secondarily transferred to the third intermediate transfer body 30. On the other hand, the black and cyan toner images primarily transferred to the second intermediate transfer body 28 are secondarily transferred to the third intermediate transfer body 30. Here, the previously secondarily transferred magenta and yellow toner images and the cyan and black toner images are superposed, and a full color toner image of three colors and black is formed on the third intermediate transfer body 30.

The secondarily transferred full color toner image reaches a nip portion between the third intermediate transfer body 30 and the transfer roll 32. The recording sheet P is transferred to the nip portion from the registration roll 16 in synchronization with the timing thereof, and a full color toner image is thirdly transferred (finally transferred) onto the recording sheet P.

The recording sheet P is thereafter sent to the fixing device 100 and passes through the nip portion between the fixing roll 102 and the pressure roll 104. At this time, the full color toner image is fixed on the recording sheet P due to the operation of the heat and the pressure applied from the fixing roll 102 and the pressure roll 104. The recording sheet P is output to the tray 38 by the sheet transport roll 36 after fixing, and the full color image formation onto the recording sheet P is finished.

Next, a description will be given of the fixing device 100 in accordance with the exemplary embodiment.

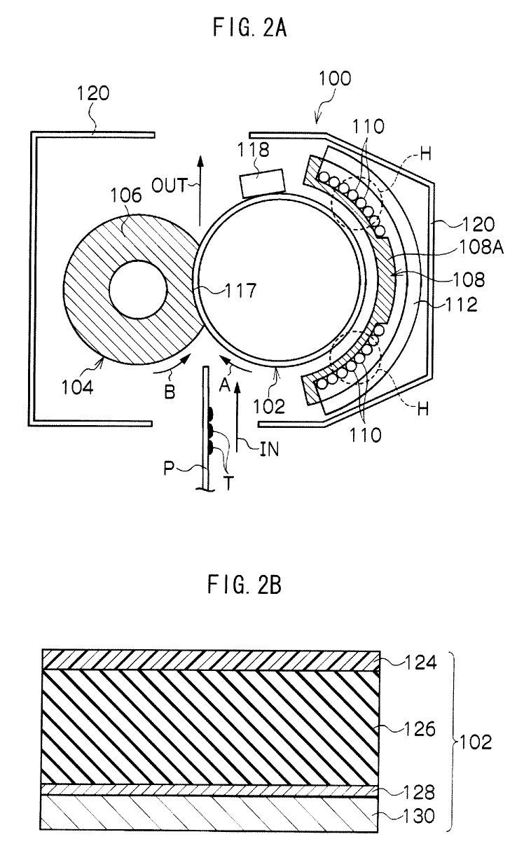

As shown in FIG. 2A, the fixing device 100 is provided with a casing 120 in which an opening for carrying out an entry or an exit of the recording sheet P is formed. The endless fixing roll 102 rotating in a direction of an arrow A is provided in an inner portion of the casing 120. A gear (not shown) is bonded to both end portions of the fixing roll 102.

A bobbin 108 constructed by an insulative material is arranged at a position opposing to an outer peripheral surface of the fixing roll 102. The bobbin 108 is formed as an approximately circular arc shape that follows the outer peripheral surface of the fixing roll 102, and a convex portion 108A is protruded from an approximately center portion of an opposite surface to the fixing roll 102. An interval between the bobbin 108 and the fixing roll 102 is set about 1 to 3 mm.

An excitation coil 110 generating a magnetic field H by being energized is wound plural times in an axial direction (the direction perpendicular to the surface of the drawing of FIG. 2A) around the convex portion 108A of the bobbin 108. A magnetic body core 112 formed approximately in a circular arc shape so as to follow the circular arc shape of the bobbin 108 is arranged at a position opposing to the excitation coil 110, and is supported to the bobbin 108.

On the other hand, the pressure roll 104 rotating in a driven manner in a direction of an arrow B with respect to the rotation of the fixing roll 102 is brought into pressure contact with the outer peripheral surface of the fixing roll 102. The pressure roll 104 is structured such that a silicon rubber elastic layer and a PFA release layer are coated around a cored bar 106 made of a metal such as steel. Further, the pressure roll 104 is formed as a concave shape that follows the outer peripheral surface of the fixing roll 102, in a nip portion 117 corresponding to a contact portion with the fixing roll 102.

A separating pawl (not shown) having a lead edge portion directed to the fixing roll 102 side is provided in the vicinity of an outlet side in a transport direction of the recording sheet P of the nip portion 117, and prevents the recording sheet P mounting the toner T thereon from being drawn to the fixing roll 102 side at a time when the recording sheet P passes through the nip portion 117. Accordingly, the recording sheet P transported from a direction of an arrow IN is output to a direction of an arrow OUT.

A thermistor 18 measuring a temperature of the surface of the fixing roll 102 is provided in a contact manner in a region which does not oppose to the excitation coil 110 and a region which is close to the output side of the recording sheet P, on the surface of the fixing roll 102. A contact position of the thermistor 118 comes to an approximately center portion in the axial direction of the fixing roll 102 (the direction perpendicular to the surface of the drawing of FIG. 2A), in such a manner as to prevent a measured value from being varied in accordance with a magnitude of a size of the recording sheet P. The thermistor 118 measures a temperature of the surface of the fixing roll 102 on the basis of a variation of a resistance value in correspondence to a heat quantity given from the surface of the fixing roll 102.

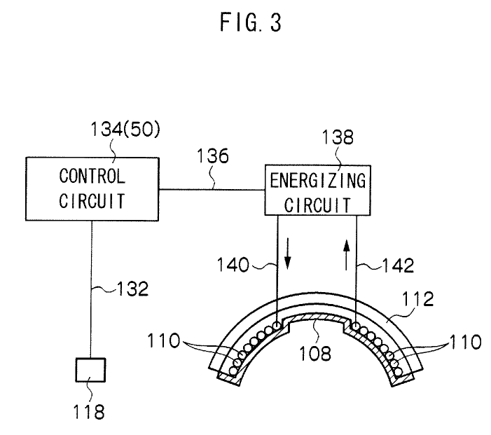

As shown in FIG. 3, the thermistor 118 is connected to a control circuit 134 provided in an inner portion of the control unit 50 (refer to FIG. 1) mentioned above via a wiring 132. Further, the control circuit 134 is connected to an energizing circuit 138 via a wiring 136, and the energizing circuit 138 is connected to the excitation coil 110 mentioned above via wirings 140 and 142.

Here, the control circuit 134 measures the temperature of the surface of the fixing roll 102 on the basis of a quantity of electricity sent from the thermistor 118 so as to compare the measured temperature with a previously stored set fixing temperature (170° C. in the exemplary embodiment). Further, in the case that the measured temperature is lower than the set fixing temperature, it drives the energizing circuit 138 so as to excite the excitation coil 110, and generates a magnetic field H (refer to FIG. 2A) serving as a magnetic circuit. On the other hand, in the case that the measured temperature is higher than the set fixing temperature, it stops the energizing circuit 138.

The energizing circuit 138 is driven or stopped based on an electric signal sent from the control circuit 134, and is configured to send, or stop sending, an alternating current having a predetermined frequency to the excitation coil 10 via the wirings 140 and 142.

Next, a description will be given of the structure of the fixing roll 102. Note that, in the exemplary embodiment, the fixing roll 102 has a structure which does not deform in a concave shape while deforming at the nip portion 117, or a structure in which it is not necessary to independently provide a pressing member at an inner peripheral surface of the fixing member for forming the nip portion opposing the pressure rotating body, and the fixing belt has a structure which is deformed in a concave shape, or a structure in which it is necessary to independently provide a pressing member at an inner peripheral surface of the fixing member for forming the nip portion opposing the pressure rotating body.

The fixing roll 102 is constructed by a temperature sensing layer 130 having a thickness 200 μm (between 150 and 200 μm) from an inner side toward an outer side, a heat generating layer 128 having a thickness 10 μm (between 2 and 20 μm), an elastic layer 126 having a thickness 400 μm, and a release layer 124 having a thickness 30 μm, as shown in FIG. 2B, and they are laminated and integrated. A diameter of the fixing roll 102 is set to 30 mm.

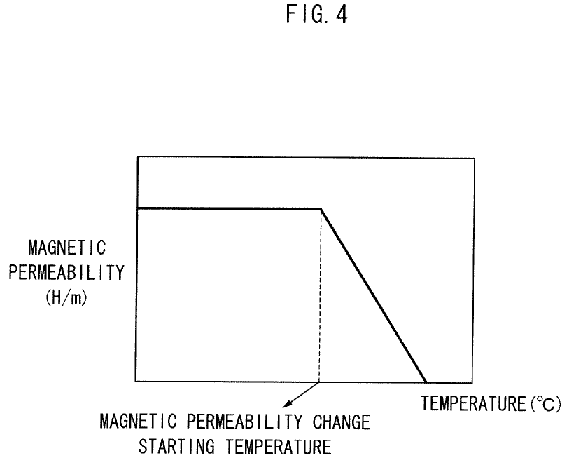

The temperature sensing layer 130 is positioned in a base layer for maintaining strength of the fixing roll 102, and employs a metal magnetically soft material including an alloy of at least one of steel, nickel, chrome, silicone, boron, niobium, copper, zirconium or cobalt, or the like. Further, the temperature sensing layer 130 employs a material having a magnetic permeability change starting temperature, at which a magnetic permeability starts to continuously decrease, in a temperature range from a set fixing temperature (a fixing temperature necessary for the fixing roll 102) of the fixing device 100 to a heat resisting temperature (a temperature at which deformation begins due to heat) of the heat generating layer 128 (or the fixing roll 102). Note that, the magnetic permeability change starting temperature is a temperature at which the magnetic permeability (measured in accordance with JIS-C2531) starts to decrease continuously, and means a point at which a penetration amount of the magnetic flux of the magnetic field starts changing, as shown in FIG. 4.

On the basis of the above, the exemplary embodiment sets a heat resisting temperature to 240° C. and a fixing temperature to 170° C. and as the temperature sensing layer 130, employs an iron-nickel alloy having a magnetic permeability change starting temperature of about 200° C. A specific resistance of the temperature sensing layer 130 is 70×10⁻⁸Ω or more.

The temperature sensing layer 130 comes to a ferromagnetic material at a lower temperature than the magnetic permeability change starting temperature, and makes the magnetic field H (refer to FIG. 2A) mentioned above intrude. Further, if it exceeds the magnetic permeability change starting temperature, the magnetic permeability thereof starts to decrease so as to come close to that of a non-magnetic material (a paramagnetic material), and a magnetic flux penetrating amount of the magnetic field H is increased.

Here, in order to sufficiently generate a temperature sensing function of the temperature sensing layer 130, it is necessary to set a skin depth δ indicating a depth at which the magnetic field H may intrude at a lower temperature than the magnetic permeability change starting temperature to a thickness of the temperature sensing layer 130 or less. The skin depth 6 is given by the following formula (1).

$$\begin{matrix}[ Formula 1 ] & \\ δ = 503 \sqrt{\frac{ρ}{f \cdot {μ}_{r}}} & ( 1 )\end{matrix}$$

In the formula (1), ρ indicates a specific resistance, f indicates a frequency (an electromagnetic induction heating frequency), and μᵣ indicates a relative magnetic permeability (room temperature). Here, determining the relative magnetic permeability, for example, achieving δ≦200 μm on the basis of the formula (1), under a necessary condition ρ≧70×10⁻⁸ Ωm, f≧20 kHz, at least the relative magnetic permeability μᵣ≧230 is required. The temperature sensing layer 130 in accordance with the exemplary embodiment is previously set to a high magnetic permeability in accordance with a heat treatment (an annealing) in such a manner that the relative magnetic permeability μᵣ becomes 230 or more. The specific resistance ρ is determined in accordance with a method of JIS K6911.

Note that, since the specific resistance of the temperature sensing layer 130 is sufficiently high, for example, at a thickness of 200 μm, and when the electromagnetic induction heating frequency is from 20 kHz to 100 kHz, the temperature sensing layer 130 does not readily generate heat in comparison with the heat generating layer 128. Accordingly, the temperature sensing layer 130 rarely generates excessive heat to an extent that affects the heat generating temperature of the heat generating layer 128. Further, the temperature sensing layer 130 is designed to be 150 μm or more to secure sufficient strength of the fixing roll 102.

On the other hand, the heat generating layer 128 employs a metal material generating heat due to electromagnetic induction action that eddy current flows in such a manner as to generate a magnetic field canceling the magnetic field H (refer to FIG. 2A) mentioned above. As the metal material mentioned above, for example, there may be employed gold, silver, copper, aluminum, zinc, tin, lead, bismuth, beryllium, antimony or an alloy thereof Further, in order to shorten a warm-up time of the fixing device 100, the thickness of the heat generating layer 128 may be made as thin as possible, and if the heat generating layer 128 employs a non-magnetic metal material in which the thickness is between 2 and 20 μm, and the specific resistance is 2.7×10⁻⁸ Ωcm or less, the heat generating amount which is necessary in the range of alternating frequency between 20 kHz and 100 kHz which a general-use power supply can utilize may be efficiently obtained. In the exemplary embodiment, copper is used and the thickness is set to 10 μm to obtain favorable heat generating efficiency and low costs. Since this thickness is sufficiently thinner than the skin depth δ, this allows the magnetic flux to pass through.

The elastic layer 126 employs a silicone rubber or a fluorine-contained rubber to obtain excellent elasticity and heat resistance, and employs silicone rubber in the exemplary embodiment.

The release layer 124 is provided for weakening an adhesive force with the toner T (refer to FIG. 2A) fused on the recording sheet P and making the recording sheet P be easily peeled off from the fixing, roll 102. In order to obtain an excellent surface mold release characteristic, a fluorine-contained resin, a silicone resin or a polyimide resin is used as the release layer 124, and a tetrafluoroethylene perfluoro alkoxy ethylene copolymerization resin (PFA) is used in the exemplary embodiment.

Next, a description will be given of an operation of the first exemplary embodiment in accordance with the invention.

As shown in FIGS. 1 to 3, the recording sheet P to which the toner T is transferred is sent to the fixing device 100 via the image forming step of the printer 10. In the fixing device 100, the fixing roll 102 starts its rotational drive in the direction of the arrow A, and the pressure roll 104 rotates in the direction of the arrow B in accordance therewith. At this time, the energizing circuit 138 is driven on the basis of an electric signal from the control circuit 134, and alternating current is supplied to the excitation coil 110.

If the alternating current is supplied to the excitation coil 110, generation and extinction of the magnetic field H serving as the magnetic circuit are repeated at the periphery of the excitation coil 110. Further, if the magnetic field H traverses the heat generating layer 128 of the fixing roll 102, eddy current (not shown) is generated in the heat generating layer 128 such that a magnetic field that impedes changes in the magnetic field H arises.

The heat generating layer 128 generates heat in proportion to the skin resistance of the heat generating layer 128 and the magnitude of the eddy current flowing through the heat generating layer 128, whereby the fixing roll 102 is heated. The temperature of the surface of the fixing roll 102 is detected by the thermistor 118, and in the case that the temperature does not reach the set fixing temperature 170° C., the control circuit 134 drives and controls the energizing circuit 138 so as to apply alternating current having a predetermined frequency to the excitation coil 110. Further, in the case that the temperature reaches the set fixing temperature, the control circuit 134 stops the control of the energizing circuit 138.

Subsequently, as shown in FIG. 2A, the recording sheet P fed to the fixing device 100 is heated and pressed by the fixing roll 102 in which the heat generating layer 128 generates heat so as to reach the predetermined set fixing temperature (170° C.). and the pressure roll 104, and the toner image T is fixed onto the surface of the recording sheet P. The recording sheet P exited the fixing device 100 is output to the tray 38 by the sheet transport roll 36.

Here, a description will be given of a case that the recording sheet P having a small size is continuously supplied so as to be fixed, and the recording sheet having a large size is subsequently supplied.

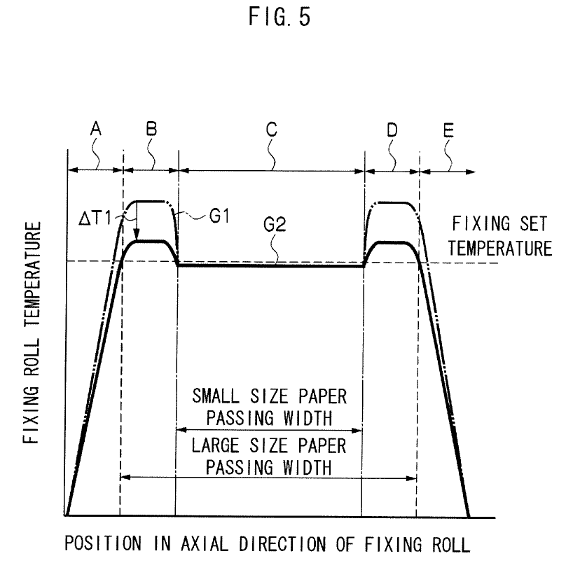

As shown in FIGS. 2A and 5, in the fixing roll 102, a region through which the recording sheet P having a small size passes is set to C, a region through which the recording sheet P having a large size passes is set to B+C+D, and a region through which the recording sheet P does not pass and in which the excitation coil 110 is not arranged is set to A and E. Further, G1 is a temperature graph of the fixing roll in a case when the temperature sensing layer 130 is not provided, or the magnetic permeability change starting temperature of the temperature sensing layer 130 is not between 170° C. and 240° C., and G2 is a temperature graph of the fixing roll 102 in accordance with the exemplary embodiment.

First of all, if the recording sheet P having the small size is continuously supplied so as to be fixed, the heat quantity is absorbed by the recording sheet P and the temperature of the fixing roll 102 becomes lower than the set fixing temperature (170° C.), in the passing region C of the recording sheet P in the fixing roll 102.

The control circuit 134 (refer to FIG. 3) controls the energizing circuit 138 in such a manner as to approximate the temperature of the fixing roll 102 to the set fixing temperature, on the basis of a difference between the temperature detected by the thermistor 118 and the set fixing temperature, and the heat generating layer 128 generates heat. Due there to, the temperature of the fixing roll 102 rises. Since the heat quantity is not absorbed by the recording sheet P, in the non-passing regions B and D (including A and E) of the recording sheet P in the fixing roll 102, the temperature further rises due to the heat generation of the heat generating layer 128.

In the case of using the fixing roll in which the temperature sensing layer 130 is not provided, or the magnetic permeability change starting temperature of the temperature sensing layer 130 does not exist between 170° C. and 240° C., there is not provided with the means for reducing the temperature rise in the non-passing regions B and D of the recording sheet P. Accordingly, the temperature difference between the passing region C of the recording sheet P and the non-passing regions B and D thereof in the fixing roll becomes larger as shown by the graph G1.

If the temperature difference between the passing region C of the recording sheet P and the non-passing regions B and D thereof becomes large, an excessive heat quantity is given to the end portion (the regions B and D) of the recording sheet P at a time of fixing the recording sheet P having the large size after the recording sheet P having the small size, there is generated a so-called hot offset phenomenon that a part of the toner T remains in the fixing roll side, and a fixing unevenness of the image is generated.

In the fixing device 100 in accordance with the exemplary embodiment, the temperature rises in the non-passing regions B and D of the recording sheet P, and, when the temperature of the surface of the fixing roll 102 becomes higher than the set fixing temperature 170° C. and exceeds the magnetic permeability change starting temperature 200° C., the relative magnetic permeability of the temperature sensing layer 130 in the non-passing regions B and D starts to approach 1. At this time, the skin depth δ determined by the formula (1) mentioned above becomes larger than the thickness of the temperature sensing layer 130, and the magnetic flux of the magnetic field H passes through the temperature sensing layer 130. Accordingly a magnetic flux density of the magnetic field H is reduced and an eddy current caused by the electromagnetic induction is reduced, whereby the heat generating quantity of the heat generating layer 128 is lowered in the non-passing region of the recording sheet P.

As mentioned above, in the non-passing regions B and D of the recording sheet P in the fixing roll 102, the fixing temperature is lowered at ΔT1 in comparison with when the temperature sensing layer 130 is not provided, and the temperature rise is lowered.

Note that, in the passing region C of the recording sheet P in the fixing roll 102, since the temperature of the temperature sensing layer 130 does not reach the magnetic permeability change starting temperature 200° C., and temperature sensing layer 130 remains as a ferromagnetic material, the heat generating quantity of the heat generating layer 128 is not lowered, and the temperature rises up to the set fixing temperature 170° C.

As described above, since the temperature difference is lowered between the passing region C of the recording sheet P and the non-passing regions B and D thereof in the fixing roll 102, and the temperature distribution becomes as shown in the graph G2, the hot offset phenomenon mentioned above is not likely to be generated at an end portion of the recording sheet P having the large size even if the recording sheet P having the large size is fixed after fixing the recording sheet P having the small size.

Further, a shape of the nip portion 117 is convex to the pressure roll 104 side, and an outer shape of the fixing roll 102 comes to a held state. Accordingly, a compression force or a tension force is hard to be applied to the heat generating layer 128 of the fixing roll 102.

Next, a description will be given of a second exemplary embodiment of the fixing device and the image forming device in accordance with the invention with reference to the accompanying drawings. Note that, the same reference numerals are applied to parts which are basically the same as those of the first exemplary embodiment mentioned above, and a description thereof will be omitted.

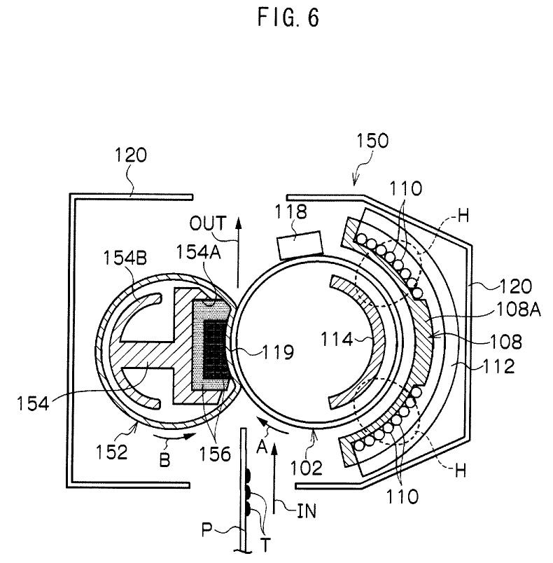

A fixing device 150 is shown in FIG. 6. An endless pressure belt 152 is used in the fixing device 150 in place of the pressure roll 104 of the fixing device 100 in accordance with the first exemplary embodiment. The pressure belt 152 is structured such that a release layer made of PFA having a thickness 30 μm is coated on an endless base layer made of a polyimide having a thickness 100 μm.

A support member 154 is provided inside the pressure belt 152 so as to extend along a width direction of the pressure belt 152. The support member 154 is structured such that a concave portion 154A is formed in an opposing side to a nip portion 119 with which the fixing roll 102 and the pressure belt 152 come into contact, and a circular arc portion 154B is formed in an opposite side to the concave portion 154A.

Note that, the support member 154 is provided with a support shaft (not shown) in both ends portions in a longitudinal direction, and the support shaft is fixed to a casing 120. Further, a discoid cap (not shown) provided with a bearing inserted on the exterior of the support shaft is attached to both end portions of the pressure belt 152, and the pressure belt 152 is rotatably pivoted. The pressure belt 152 is rotated in accordance with a rotation of the fixing roll 102.

A pressure pad 156 made of a heat resisting resin (two layers) such as a liquid crystal polymer (LCP) is bonded to the concave portion 154A of the support member 154. The pressure pad 156 comes into contact with an inner peripheral surface of the pressure belt 152, and presses the nip portion 119.

On the other hand, a induction body 114 is provided at a position opposing to the excitation coil 110 inside the fixing roll 102 in the fixing device 150 so as to be in non-contact with the fixing roll 102. The induction body 114 is made of aluminum that is a non-magnetic body, is formed in a circular arc shape along the fixing roll 102. and is fixed to the casing 120 in both ends. Further, a resistance value of the induction body 114 is 2.7×10⁻⁸ Ωm or less. Note that, the position of the induction body 114 is set to a position that induces the magnetic flux of the magnetic field H in the case that the magnetic flux of the magnetic field H passes through the fixing roll 102. The induction body 114 is spaced from the fixing belt 102 by 1.5 mm (1 to 5 mm).

Next, a description will be given of an operation of the second exemplary embodiment in accordance with the invention.

As shown in FIG. 6, the recording sheet P to which the toner T is transferred is sent to the fixing device 150 via the image forming step. In the fixing device 150, the fixing roll 102 starts its rotational drive in the direction of the arrow A, and the pressure belt 152 rotates in the direction of the arrow B in accordance therewith. At this time, the energizing circuit 138 is driven on the basis of an electric signal from the control circuit 134 (refer to FIG. 3), and alternating current is supplied to the excitation coil 110.

If the alternating current is supplied to the excitation coil 110, generation and extinction of the magnetic field H serving as the magnetic circuit are repeated at the periphery of the excitation coil 110. Further, if the magnetic field H traverses the heat generating layer 128 of the fixing roll 102, eddy current (not shown) is generated in the heat generating layer 128 such that a magnetic field that impedes changes in the magnetic field H arises.

The heat generating layer 128 generates heat in proportion to the magnitude of the skin resistance of the heat generating layer 128 and the eddy current flowing through the heat generating layer 128, whereby the fixing roll 102 is heated. The temperature of the surface of the fixing roll 102 is detected by the thermistor 118, and in the case that the temperature does not reach the set fixing temperature 170° C., the control circuit 134 drives and controls the energizing circuit 138 so as to apply alternating current having a predetermined frequency to the excitation coil 110. Further, in the case that the temperature reaches the set fixing temperature, the control circuit 134 stops the control of the energizing circuit 138.

Subsequently, the recording sheet P fed to the fixing device 150 is heated and pressed by the pressure belt 152 and the fixing roll 102 which has reached a predetermined set fixing temperature (170° C.) due to heat generated by the heat generating layer 128, and the toner image T is fixed onto the surface of the recording sheet P. The recording sheet P exited the fixing device 150 is output to the tray 38 by the sheet transport roll 36.

Here, a description will be given of a case that the recording sheet P having a small size is continuously supplied so as to be fixed, and the recording sheet having a large size is subsequently supplied, in the fixing device 150.

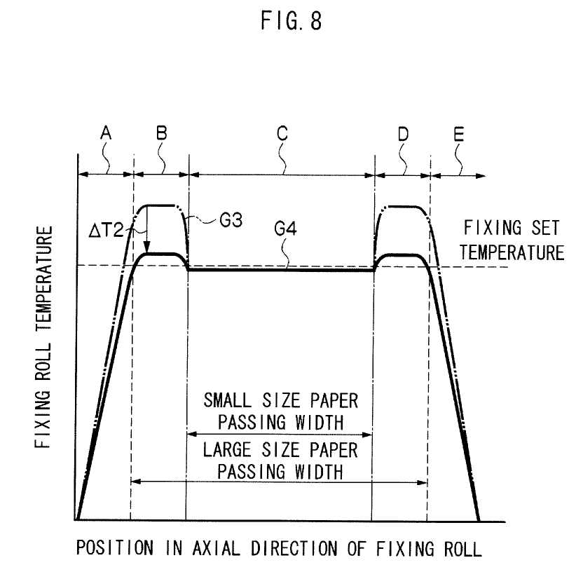

As shown in FIGS. 6 and 8, in the fixing roll 102, a region through which the recording sheet P having the small size passes is set to C, a region through which the recording sheet P having the large size passes is set to B+C+D, and a region through which the recording sheet P does not pass and in which the excitation coil 110 is not arranged is set to A and E. Further, G3 is a temperature graph of the fixing roll in the case that the temperature sensing layer 130 is not provided, or the magnetic permeability change starting temperature of the temperature sensing layer 130 does not exist between 170° C. and 240° C., and G4 is a temperature graph of the fixing roll 102 in accordance with the exemplary embodiment.

First of all, if the recording sheet P having the small size is continuously supplied so as to be fixed, the heat quantity is absorbed by the recording medium P and the temperature of the fixing roll 102 becomes lower than the set fixing temperature (170° C.), in the passing region C of the recording sheet P in the fixing roll 102.

The control circuit 134 (refer to FIG. 3) controls the energizing circuit 138 in such a manner as to approximate the temperature of the fixing roll 102 to the set fixing temperature, on the basis of a difference between the temperature detected by the thermistor 118 and the set fixing temperature, and the heat generating layer 128 generates heat. Due thereto, the temperature of the fixing roll 102 rises. Since the heat quantity is not absorbed by the recording sheet P, in the non-passing regions B and D (including A and E) of the recording sheet P in the fixing roll 102, the temperature further rises on the basis of the heat generation of the heat generating layer 128.

In the case of using the fixing roll in which the temperature sensing layer 130 is not provided, or the magnetic permeability change starting temperature of the temperature sensing layer 130 does not exist between 170° C. and 240° C., there is not provided with means for reducing the temperature rise in the non-passing regions B and D of the recording sheet P. Accordingly, the temperature difference between the passing region C of the recording sheet P and the non-passing regions B and D thereof in the fixing roll becomes larger as shown by the graph G3, and if the continuous sheet feeding is carried over, the temperature exceeds the heat resisting temperature so as to break the elastic layer 126 and the release layer 124 of the fixing roll 102.

If the temperature difference between the passing region C of the recording sheet P and the non-passing regions B and D thereof becomes large, an excessive heat quantity is given to the end portion (the regions B and D) of the recording sheet P at a time of fixing the recording sheet P having the large size after the recording sheet P having the small size, there is generated a so-called hot offset phenomenon that a part of the toner T remains in the fixing roll side, and a fixing unevenness of the image is generated.

In the fixing device 150 in accordance with the exemplary embodiment, the temperature rises in the non-passing regions B and D of the recording sheet P, and, when the temperature of the surface of the fixing roll 102 becomes higher than the set fixing temperature 170° C. and exceeds the magnetic permeability change starting temperature 200° C., the relative magnetic permeability of the temperature sensing layer 130 in the non-passing regions B and D starts to approach 1. At this time, the skin depth δ determined by the formula (1) mentioned above becomes larger than the thickness of the temperature sensing layer 130, and the magnetic flux of the magnetic field H passes through the temperature sensing layer 130.

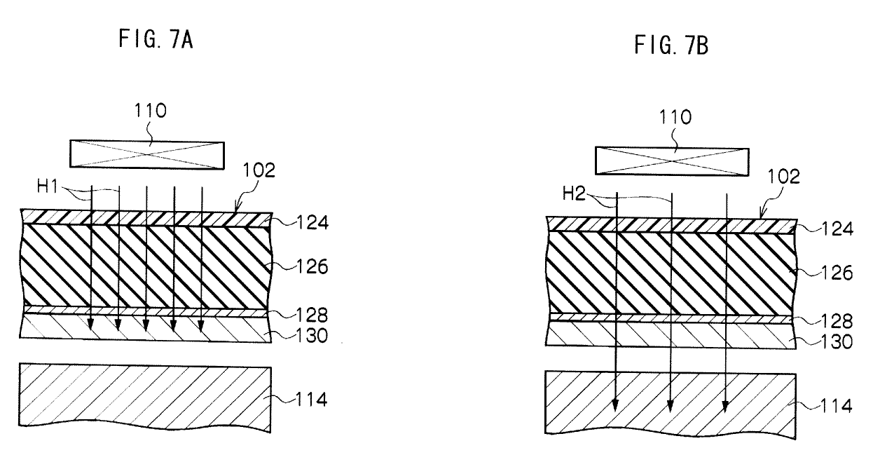

Here, FIG. 7A shows a case that the temperature of the temperature sensing layer 130 is the magnetic permeability change starting temperature or less, and FIG. 7B shows a case that the temperature of the temperature sensing layer 130 is the magnetic permeability change starting temperature or more of the temperature sensing layer 130.

As shown in FIG. 7A, in the case that the temperature of the temperature sensing layer 130 is the magnetic permeability change starting temperature or less, a magnetic field H1 passing through the heat generating layer 128 makes an intrusion into the temperature sensing layer 130 so as to form a closed magnetic path, and strengthens the magnetic field H1, because the temperature sensing layer 130 is constituted by a ferromagnetic material. Accordingly, the heat generating quantity of the heat generating layer 128 can be sufficiently obtained.

On the other hand, as shown in FIG. 7B, in the case that the temperature of the temperature sensing layer 130 is the magnetic permeability change starting temperature or more, a magnetic field H2 passes through the temperature sensing layer 130 and the magnetic field H2 is weakened. The magnetic field H2 passes through the temperature sensing layer 130, and is thereafter directed to the induction body 114. In the induction body 114 a closed magnetic path is formed from the magnetic body core 112 to the induction body 114, and eddy current flows on the basis of an operation of the magnetic field H2 however, the heat generating amount is small because its resistance is small. Further, since it does not come into contact with the fixing roll 102, it does not raise the temperature of the fixing roll 102.

Here, since the eddy current is reduced in the heat generating layer 128 in contrast to the increase of the eddy current in the induction body 114, the heat generating amount is reduced. As mentioned above, the heat generating amount of the heat generating layer 128 decreases in the non-passing region of the recording sheet P, and compared to when the temperature sensing layer 130 is not provided, the fixing temperature decreases at ΔT2, and the temperature rise decreases in the non-passing regions B and D of the recording sheet P in the fixing roll 102.

Note that, since the temperature rise of the non-passing regions B and D is lowered in the case that the induction body 114 is provided, ΔT2 of the second exemplary embodiment becomes larger than ΔT1 of the first exemplary embodiment.

As described above, since the temperature difference is lowered between the passing region C of the recording sheet P and the non-passing regions B and D thereof in the fixing roll 102, and the temperature distribution becomes as shown in the graph G4, the hot offset phenomenon mentioned above is not likely to be generated at an end portion of the recording sheet P having a large size, even if the recording sheet P having a large size is fixed after fixing the recording sheet P having a small size.

Further, a shape of the nip portion 119 is convex at a pressure belt 152 side, and an outer shape of the fixing roll 102 is maintained. Accordingly, a compression force or a tension force is not likely to be applied to the heat generating layer 128 of the fixing roll 102, and a durability is higher in comparison with when the fixing belt is used.

Note that, the invention is not limited to the exemplary embodiment mentioned above.

The printer 10 may be structured such as to use a liquid developer in addition to a dry type electrophotographic system using a solid developer. Further, a thermo couple may be used in place of the thermistor 118 as a detecting device of the temperature of the fixing roll 102.

The attaching position of the thermistor 118 is not limited to the surface of the fixing roll 102, but may be set to an inner peripheral surface of the fixing roll 102. In this case, the surface of the fixing roll 102 is not likely to be worn. Further, the thermistor 118 may be attached to the surface of the pressure roll 104.

The excitation coil 110 may be arranged inside the fixing roll 102.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a magnetic field generating unit that generates a magnetic field;
a cylindrical fixing member that is disposed to face the magnetic field generating unit, generates heat due to electromagnetic induction of the magnetic field, and includes a heat generating layer that has a thickness thinner than a skin depth, and a temperature sensing layer which has a magnetic permeability change starting temperature, in a temperature range from a set fixing temperature to a heat resisting temperature, at which a magnetic permeability starts to decrease continuously, and which contacts with a face of the heat generating layer opposite to the magnetic field generating unit; and
a pressure rotating body that is brought into pressure contact with an outer peripheral surface of the fixing member and deformed.

2. The fixing device according to claim 1, wherein the pressure rotating body comprises an endless belt member and a support member, and the belt member is sandwiched between the fixing member and the support member.

3. The fixing device according to claim 1, wherein a non-magnetic metal member is disposed inside of or outside of the fixing member to face the magnetic field generating unit, with the fixing member sandwiched therebetween.

4. The fixing device according to claim 1, wherein the fixing member deforms at a contact portion with the pressure rotating body, but is not deformed concavely.

5. The fixing device according to claim 4, wherein the pressure rotating body deforms at the contact portion with the fixing member to a greater extent than the fixing member deforms.

6. The fixing device according to claim 1, wherein the temperature sensing layer has a thickness in a range of from 150 to 200 μm.

7. The fixing device according to claim 1, wherein the heat generating layer includes at least one of gold, silver, copper, aluminum, zinc, tin, lead, bismuth, beryllium and antimony, or an alloy thereof

8. The fixing device according to claim 3, wherein the non-magnetic metal member is arranged in a position that induces a magnetic flux passing through the fixing member.

9. The fixing device according to claim 3, wherein the non-magnetic metal member includes aluminum.

10. An image forming device comprising:
the fixing device according to any one of claim 1;
an exposure section that emits exposure light;
a developing section that develops a latent image formed by the exposure light by a developer to form a developer image;
a transfer section that transfers the developer image onto a recording medium;, and
a transporting section that transports the recording medium to the fixing device.

11. A cylindrical heat fixing roll disposed to face a magnetic field generating source, comprising:
a heat generating layer that generates heat due to an electromagnetic induction of a magnetic field generated by the magnetic field generating source, and that has a thickness thinner than a skin depth; and
a temperature sensing layer that has a magnetic permeability change starting temperature, at which a magnetic permeability starts to decrease continuously, in a temperature range from a fixing temperature to a heat resisting temperature, and that is provided at a face of the heat generating layer opposite to the magnetic field generating source.
